(19) United States
(12) Patent Application Publication
(10) Pub. No.: US 2016/0233036 A1
(43) Pub. Date: Aug. 11, 2016

(54) SWITCH DEVICE

(71) Applicant: Panasonic Intellectual Property Management Co., Ltd., Osaka-shi, Osaka (JP)

(72) Inventor: Katsuichi MINAMI, Fukui (JP)

(21) Appl. No.: 15/023,680

(22) PCT Filed: Nov. 11, 2014
(86) PCT No.: PCT/JP2014/005655

§ 371 Date: Mar. 22, 2016

(30) Foreign Application Priority Data
Dec. 9, 2013 (JP) 2013-253861
Mar. 25, 2014 (JP) 2014-061337

(51) Int. Cl. H01H 13/56; H01H 25/06

(52) U.S. Cl. CPC H01H 13/568; H01H 25/06; H01H 2201/026; H01H 2221/012; H01H 2221/044; H01H 2235/01; H01H 2235/02

(57) ABSTRACT

A switch device includes a housing, an operating body accommodated movably in the housing, a stopper to lock the operating body, a switch contact performing electrical connection and disconnection in response to the movement of the operating body, a releaser disposed in the housing, and a retainer spring disposed in the housing. The operating body includes a cam section. The stopper includes an engaging section which is engaged with the cam section upon a movement of the operating body as to lock the operating body. The releaser includes a working section projecting outward from the housing. The retainer spring urges the releaser in a predetermined direction. When the operating body is locked, one of the releaser and the retainer spring presses the stopper to engage the engaging section with the cam section and retain the engaging section at the cam section. While the engaging section is engaged with the cam section and retained with the cam section, an operation on the working section of the releaser causes the releaser to move, and causes one of the releaser and the retainer spring to move in a direction away from the stopper as to cause the engaging section to remove from the cam section. The switch device includes a small number of components with a simpler structure, and has a small size.

### TECHNICAL FIELD

The present invention relates to a switch device that performs electrical connection and disconnection between switch contacts by pressing an operating body, and the switch device includes a lock mechanism for locking the operating body at a predetermined travel position.

### BACKGROUND ART

In recent years, an input device including a rotary type input device and a push-push type switch device combined together is used for operating electronic devices, such as an air-conditioner, audio device in a vehicle. This input device is mounted to a front panel or around a console box of the vehicle. The input device is required to have a small size and assure users of fail-free operation.

FIG. 9 is an exploded perspective view of rotary input device 2 including conventional switch device 3. Rotary input device 2 includes rotary operating section 2A that is rotatable. Rotary input device 2 is disposed such that rotary operating section 2A protrudes from opening 1A of front panel 1, and switch device 3 is disposed under rotary input device 2. Rotary input device 2 and switch device 3 are connected to an air-conditioner in the vehicle.

Switch device 3 is disclosed in, for instance, PTL 1.

At the center of rotary input device 2, push button 2B movable in upward and downward directions is placed, and a pressing section laterally extending from the lower part of push button 2B presses operating body 3A of switch device 3.

An operation of rotary input device 2 will be described below. Upon push button 2B being pressed, operating body 3A moves in the in the upward and downward directions to perform electrical connection and disconnection between switch contacts provided in housing 3B of switch device 3. At this moment, a stopper urged by a plate spring is engaged with a cam section having a heart shape provided on a side surface of operating body 3A disposed inside housing 3B, thereby retaining switch device 3 at a predetermined travel position, in other words, locking switch device 3 in a locked state. A ventilating of the interior of the vehicle by inside air circulation is thus selected from an outside air introduction and an inside air circulation.

Upon push button 2B being pressed while switch device 3 is locked, the engagement between the cam section and the stopper is released, so that operating body 3A may be urged by a coil spring disposed below operating body 3A, is restored to an upward position, and falls into a release state. At this moment, electrical connection and disconnection between the switch contacts is performed, thereby the ventilation is restored to the outside air introduction originally set.

A clockwise turn of rotary operating section 2A of rotary input device 2 to position 4, which refers to a defrosting mode of a windshield of the vehicle, allows a lateral pressing section protruding outside from a lower surface of rotary operating section 2A to push backward the releaser 3C protruding from a side surface of switch device 3.

Upon being pushed, releaser 3C releases the engagement between an inner stopper and the cam section for restoring operating section 3A, which has been urged upward, to an original release position. At this moment, electrical connection and disconnection between the switch contacts is performed, so that the ventilation method by the outside air introduction may be selected in the air-conditioner, and dry air is blown to an inner side of the windshield.

In other words, a shift of operating body 3A of switch device 3 in the in the upward and downward directions allows the operating body 3A to be locked or released, and at this moment, electrical connection and disconnection between the switch contacts is performed. On the other hand, a press on a side surface of releaser 3C, protruding from the side surface of housing 3B with operating body 3A being locked, allows releaser 3C to release the engagement between the stopper and the cam section, thereby allowing operating section 3A to be restored to the release position.

### CITATION LIST

### Patent Literature

PTL 1: Japanese Patent Laid-Open Publication No. 2000-331563

### SUMMARY

A switch device includes a housing, an operating body accommodated movably in the housing, a stopper to lock the operating body, a switch contact performing electrical connection and disconnection in response to the movement of the operating body, a releaser disposed in the housing, and a retainer spring disposed in the housing. The operating body includes a cam section. The stopper includes an engaging section which is engaged with the cam section upon a movement of the operating body as to lock the operating body. The releaser includes a working section projecting outward from the housing. The retainer spring urges the releaser in a predetermined direction. When the operating body is locked, one of the releaser and the retainer spring presses the stopper to engage the engaging section with the cam section and retain the engaging section at the cam section. While the engaging section is engaged with the cam section and retained with the cam section, an operation on the working section of the releaser causes the releaser to move, and causes one of the releaser and the retainer spring to move in a direction away from the stopper as to disengage the engaging section from the cam section.

The switch device includes a small number of components with a simpler structure, and has a small size.

### BRIEF DESCRIPTION OF DRAWINGS

FIG. 1 is a sectional view of a switch device in accordance with Exemplary Embodiment 1.

FIG. 2 is an exploded perspective view of the switch device in accordance with Embodiment 1.

FIG. 3 is an enlarged plan view of a cam section of the switch device in accordance with Embodiment 1.

FIG. 4A is a sectional view of the switch device in accordance with Embodiment 1 for illustrating an operation of the switch device.

FIG. 4B is a sectional view of the switch device in accordance with Embodiment 1 for illustrating the operation of the switch device.

FIG. 4C is a sectional view of the switch device in accordance with Embodiment 1 for illustrating the operation of the switch device.

FIG. 5 is a perspective view of an input device including the switch device in accordance with Embodiment 1.

FIG. 6 is a sectional view of a switch device in accordance with Exemplary Embodiment 2.

FIG. 7 is an exploded perspective view of the switch device in accordance with Embodiment 2.

FIG. 8A is a sectional view illustrating actions of the switch device in accordance with the second embodiment.

FIG. 8B is a sectional view of the switch device in accordance with Embodiment 2 for illustrating an operation of the switch device.

FIG. 8C is a sectional view of the switch device in accordance with Embodiment 2 for illustrating the operation of the switch device.

FIG. 9 is an exploded perspective view of an input device including a conventional switch device.

### DETAILED DESCRIPTION OF PREFERRED EMBODIMENTS

### Exemplary Embodiment 1

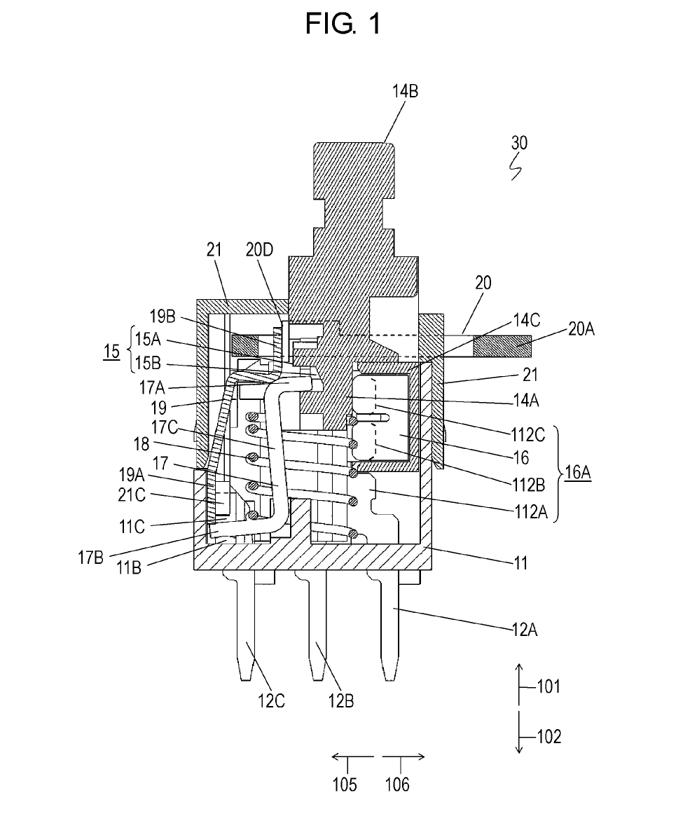

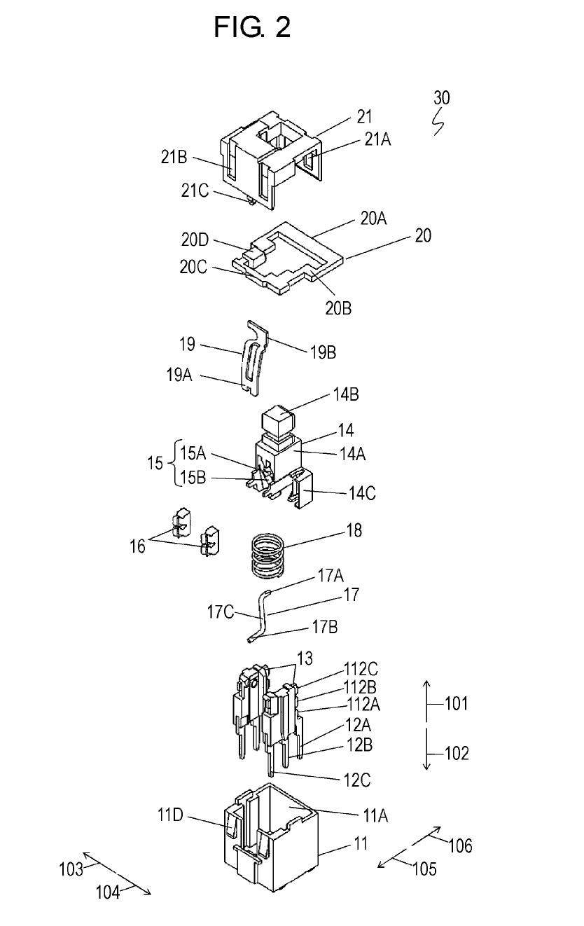

FIG. 1 and FIG. 2 are a sectional view and an exploded perspective view of switch device 30 in accordance with Exemplary Embodiment 1, respectively. Housing 11 having a box shape having an opening that opens in upward direction 101, and is made of insulating resin, such as polybutylene terephthalate (PBT).

Plural fixed contacts 112A, 112B, and 112C are made of conductive metal plates, such as copper alloy plate. These fixed contacts are insert-molded with insulating resin, such as PBT, to form fixed contact assembly 13. Fixed contacts 112A, 112B, and 112C are arranged in upward direction 101 in this order. Fixed contact assembly 13 is placed in forward direction 103 in housing 11 while fixed contact assembly 13 is placed in backward direction 104 in housing 11. Forward direction 103 and backward direction 104 are perpendicular to upward direction 101 (downward direction 102). Terminal sections 12A, 12B, and 12C are disposed on lower parts of fixed contacts 112A, 112B, and 112C, respectively, and protrude from a lower surface of housing 11 in downward direction 102. Two fixed contact assemblies 13 faces in forward direction 103 (backward direction 104). Two fixed contacts 112A (terminal section 12A) face each other in forward direction 103 (backward direction 104). Two fixed contacts 112B (terminal section 12A) face each other in forward direction 103 (backward direction 104). Two fixed contacts 112C (terminal section 12A) face each other in forward direction 103 (backward direction 104).

Operating body 14 is made of insulating resin, such as PBT or polyoxymethylene (POM). Operating body 14 includes base section 14A and operating section 14B provided on base section 14A. Operating body 14 is accommodated movably in upward direction 101 and downward direction 102 within housing 11 such that operating section 14B protrudes from opening 11A in upward direction 101.

Cam section 15 is provided on a side surface of operating section 14 in leftward direction 105 perpendicular to upward direction 101 (downward direction 102) and forward direction 103 (backward direction 104). Cam section 15 includes protrusion cam 15A having a heart shape, and groove 15B formed around protrusion cam 15A and having a groove shape. Plural steps are sequentially formed in groove 15B, and cam section 15 forms a heart-shaped cam.

Compartments 14C are provided in respective side surfaces of base section 14A of operating body 14 in forward direction 103 and backward direction 104. Each of compartments 14C accommodates therein movable contact 16 having a clip shape and made of conductive metal plate, such as phosphor bronze plate. Movable contact 16 nips fixed contacts 112A, 112B, and 112C and elastically contacts fixed contacts 112A, 112B, and 112C. To be more specific, movable contact 16 nips two fixed contacts out of the three contacts simultaneously and elastically contact the two contacts. Movable contact 16 thus elastically contacts not all the three fixed contacts simultaneously. Movable contact 16 switches switch contact 16A between a first connection state in which movable contact 16 connects fixed contact 112A to fixed contact 112B (connect terminal section 12A to terminal section 12B), and disconnects fixed contact 112C (terminal section 12C) from fixed contacts 112B, 112C (terminal sections 12B, 12C) and a second connection state in which movable contact 16 connects fixed contacts 112B to fixed contact 112C (connect terminal section 12B to terminal section 12C) and disconnects fixed contact 112A (terminal section 12A) from fixed contacts 112B, 112C (terminal sections 12B, 12C).

Movable contact 16 and fixed contacts 112A to 112C constitute switch contact 16A such that a movement of operating body 14 in upward direction 101 and downward direction 102 causes movable contact 16 to move in upward direction 101 and downward direction 102, thereby performing connection and disconnection between movable contact and fixed contacts 112A to 112C.

Stopper 17 is made of metal wire, such as a stainless wire or a piano wire. Stopper 17 includes engaging section 17A formed at the upper part thereof, supporting section 17B formed at the lower part thereof, and linear section 17C extending from engaging section 17A substantially in downward direction 102 to supporting section 17B. Engaging section 17A has substantially an L-shape bent from linear section 17C towards cam section 15 in rightward direction 106 opposite to leftward direction 105. Supporting section 17B has substantially an L-shape bent from linear section 17C in leftward direction 105 opposite to engaging section 17A.

Supporting section 17B of stopper 17 contacts an upper surface of small projection 11B on a bottom surface of housing 11 while engaging section 17A contacts groove 15B formed in the lower part of cam section 15.

Coil spring 18 is mounted between a lower surface of operating body 14 and the bottom surface of housing 11, and slightly compressed to urge operating body 14 upward. Stopper 17 extends through the inside of coil spring 18, and a lower end of coil spring 18 elastically urges supporting section 17B of stopper 17 from above to urge stopper 17 in downward direction 102 with respect to small projection 11B as a fulcrum, thereby urging engaging section 17A, i.e. an upper end of stopper 17 toward cam section 15 even with a small force.

Retainer spring 19 has substantially a rectangular shape and is made of elastic metal plate, such as stainless plate or copper-alloy plate. Retainer spring 19 includes fixing section 19A formed at the lower end thereof, and retaining section 19B formed at the upper end thereof. Fixing section 19A is held with supporting wall 11C that protrudes from the bottom surface of housing 11 near an inner wall of housing 11 in leftward direction 105. Retaining section 19B is bent to have an L-shape and contacts a side surface of engaging section 17A of stopper 17 in leftward direction 105, or disposed near the side surface of engaging section 17A of stopper 17 with a space between retaining section 19B and the side surface.

Releaser 20 has substantially a rectangular frame shape and is made of insulating resin, such as PBT or POM. Cover 21 opens in downward direction 102, and is made of insulating resin, such as PBT or POM. Releaser 20 is disposed between an upper surface of housing 11 and cover 21 such that releaser 20 surrounds an outer circumference of operating body 14. Releaser 20 is mounted to operating body 14 such that releaser 20 can move in leftward direction 105 and rightward direction 106 of operating body 14.

To be more specific, working section 20A formed on the right side of releaser 20 projects to an outside of housing 11 in rightward direction 106. Working section 20A includes slidable sections 20B at both insides in forward direction 103 and backward direction 104. Slidable sections 20B can slide in apertures 21A in cover 21 along leftward direction 105 and rightward direction 106.

Frame section 20C extends from slidable sections 20B into housing 11 and includes releasing section 20D formed inside the frame section 20C. Retaining section 19B of retainer spring 19 which is slightly compressed elastically contacts releasing section 20D, thereby urging releaser 20 in rightward direction 106.

When slidable section 20B slides in aperture 21A, a bridge between slidable section 20B and working section 20A on right side, and a bridge between slidable section 20B and frame section 20C on left side cover a space of aperture 21A, hence providing no opening This structure allows switch device 30 to keep off dust even if switch device 30 is used in a vehicle at dusty environment to stably perform electric connection and disconnection of switch contact 16A.

Cover 21 is disposed above releaser 20 in upward direction 101 and has plural engaging holes 21B provided in both side surfaces of cover 21 in leftward direction 105 and rightward direction 106. Engaging holes 21B face engaging sections 11d formed on housing 11 at both side surfaces. Engaging sections 11D of housing 11 engage with engaging holes 21B of cover 21 while cover 21 is mounted to housing 11.

Cover 21 includes restraint section 21C projecting from cover 21 at the left side lower end thereof. Restraint section 21C is disposed inside housing 11 such that restraint section 21C restrains supporting section 17B of stopper 17 from moving upward. Cover 21 covers opening 11A in the upper surface of housing 11. Switch device 30 is thus constructed.

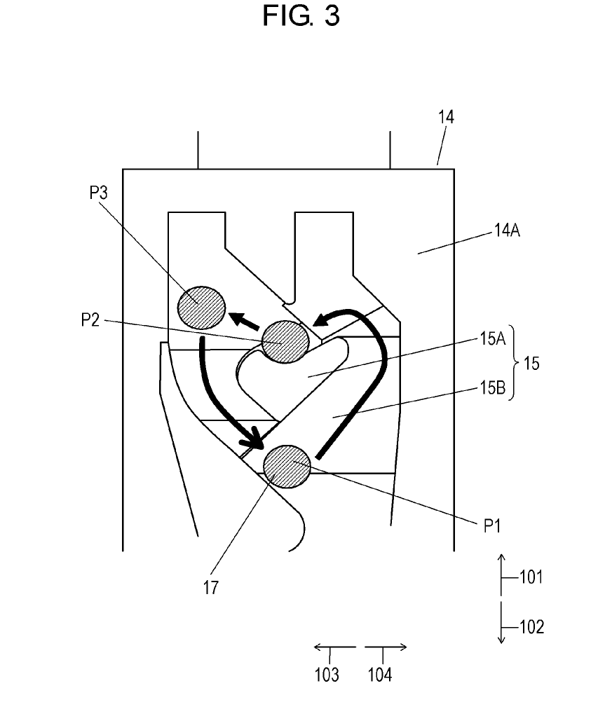

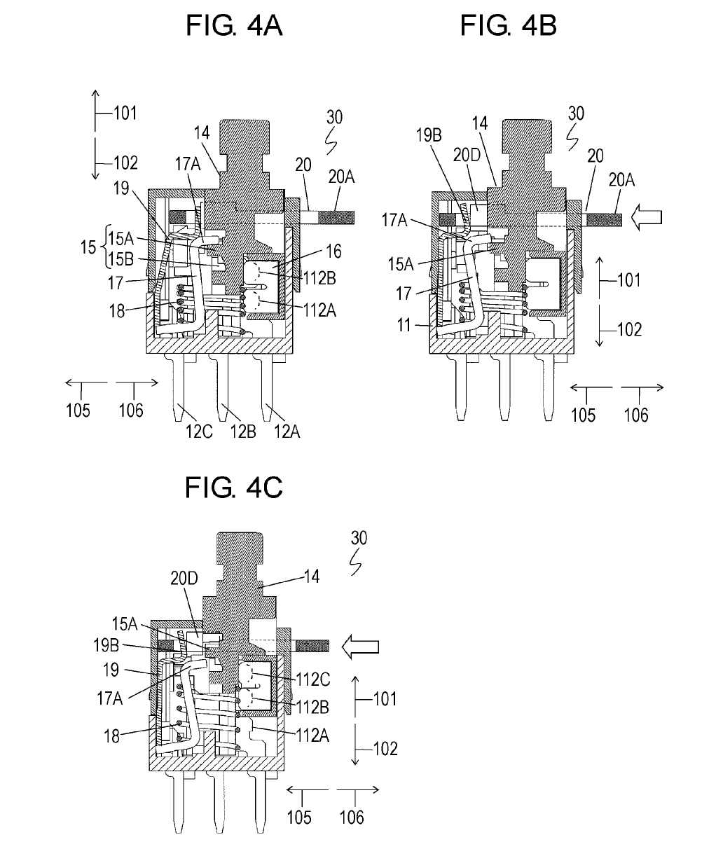

An operation of switch device 30 will be described below. FIG. 3 is an enlarged plan view of cam section 15. FIGS. 4A to 4C are sectional views of the switch device in accordance with Embodiment 1 for illustrating the operation. As shown in FIG. 1, when switch device 30 stays in a release state where operating body 14 protrudes from the upper surface of cover 21 to the most highest position, engaging section 17A of stopper 17 is located at position P1 in groove 15B below protrusion cam 15A as shown in FIG. 3.

Upon having operating section 14B pressed in downward direction 102, operating body 14 moves in downward direction 102 while compressing coil spring 18.

The movement of operating body 14 in downward direction 102 shifts switch contact 16A from the first connection state to the second connection state. To be more specific, in the first connection state, movable contact 16 elastically contacts fixed contacts 112A and 112B located above movable contact 16, so that switch contact 16A can be connected to terminal sections 12B and 12C. In the second connection state, movable contact 16 elastically contacts fixed contacts 112B and 112C located below movable contact 16, so that movable contact 16 causes terminal sections 12A and 12B to be connected with switch contact 16A.

At this moment, as shown in FIG. 3, the movement of operating body 14 in downward direction 102 causes engaging section 17A of stopper 17 to slide on the steps formed in groove 15B anticlockwise to position P2 where engaging section 17A engages with the upper surface of protrusion cam 15A, so that operating body 14 can be retained and locked at a predetermined position and locked.

In this locked state, coil spring 18 urges engaging section 17A of stopper 17 toward cam section 15 with a smaller force while coil spring 18 urges operating body 14 in upward direction 101 with a larger force. This mechanism applies a strong force to engaging section 17A as to cause engaging section 17A to slip out from the upper surface of protrusion cam 15A toward leftward direction 105. However, retainer spring 19 contacts or elastically contacts a side surface of engaging section 17A on leftward direction 105 side to keep the engagement between engaging section 17A and the upper surface of protrusion cam 15A, so that engaging section 17A may be engaged with cam section 15 without fail and the locked state is maintained.

Next, upon having operating section 14B pressed again, operating body 14 moves to the lowest position, i.e. full-stroke position, and engaging section 17A slides anticlockwise to position P3 from position P2 which is located at the upper part of protrusion cam 15A, thereby releasing the engagement of engaging section 17A with protrusion cam 15A, and unlocking operating body 14.

Then, operating body 14 is urged in upward direction 101 and is restored to the original release position shown in FIG. 1, and engaging section 17A is restored to position P1 shown in FIG. 3, so that switch contact 16A falls in the first connection state.

When switch device 30 stays in the locked state as shown in FIG. 4A, working section 20A, of releaser 20 protruding from the right side of switch device 30 is pushed in leftward direction 105, then releasing section 20D slides in leftward direction 105 while releasing section 20D pushes retaining section 19B of retainer spring 19 in leftward direction 105, as shown in FIG. 4B.

At this moment, as shown in FIG. 4C, retainer spring 19 pushed by releasing section 20D elastically deforms in leftward direction 105, and retaining section 19B is removed from engaging section 17A of stopper 17, thus releasing the engagement of engaging section 17A with protrusion cam 15A. As a result, operating body 14 is unlocked, and urged by coil spring 18 to be restored to the release position.

Then, the pushing of working section 20A is released, releaser 20 urged rightward by retainer spring 19 slides in rightward direction 106. Releaser 20 is thus restored to an original position and protrudes to an outside of housing 11 in rightward direction 106.

As discussed above, switch device 30 is locked and unlocked by moving operating body 14 in upward direction 101 and downward direction 102 while performing the electric connection and disconnection to switch contact 16A. Working section 20A of releaser 20 protruding outward from the side surface of housing 11 in the locked state is pushed toward housing 11 to cause releaser 20 to slide. This operation allows releasing section 20D of releaser 20 to cause retainer spring 19 to deform elastically in leftward direction 105 opposite to the direction toward cam section 15. Retaining section 19B is thus removed from engaging section 17A of stopper 17, and releases the engagement of engaging section 17A with cam section 15, thereby unlocking operating body 14.

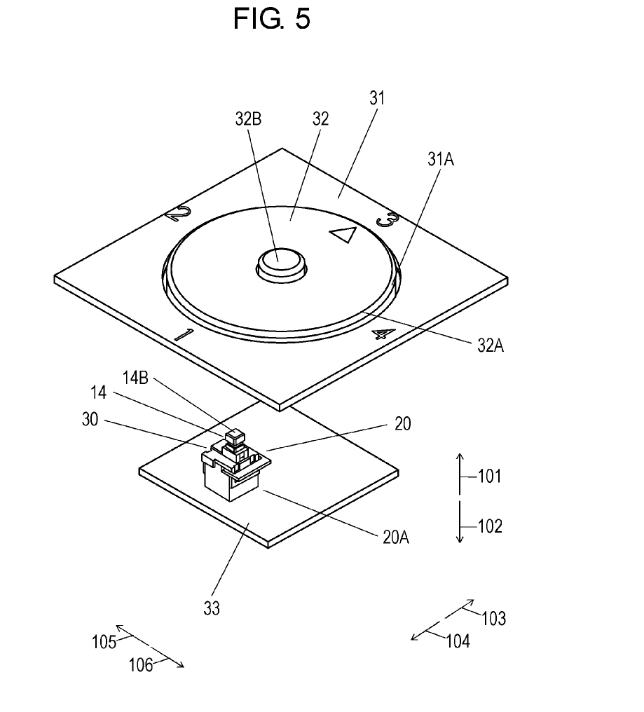

FIG. 5 is an exploded perspective view of input device 32 including switch device 30. Input device 32 is mounted to a vehicle, and includes rotary operating section 32A. Input device 32 is disposed such that operating section 32A protrudes from opening 31A of front panel 31 in the vehicle. Switch device 30 is disposed below input device 32. Switch device 30 is mounted to wiring board 33 by soldering terminal section 12A to wiring board 33.

Push button 32B is mounted to the center of input device 32 while the push button is movable in upward and downward directions. Switch device 30 is placed such that operating section 14B extending outside can be pushed with push button 32B.

Input device 32 and switch device 30 are connected to, for instance, an electric circuit of the vehicle via wiring board 33 disposed below input device 32 and switch device 30, thus providing an input device for operating an air-conditioner.

Upon being pushed, push button 32B presses operating section 14B via a pushing section at the lower part of push button 32B, and a movement of operating body 14 in downward direction 102 brings switch contact 16A from the first connection state into the second connection state. A signal indicating the second connection state is transmitted to the electric circuit of the vehicle, and the signal selects air circulation from modes for air-intake in the interior of the vehicle, namely, an outside air introduction, and an inside air circulation. Then, the air of the interior is circulated.

At this moment, operating body 14 is retained at a predetermined position by the engagement of stopper 14 with cam section 15, and falls in a locked state.

Next, upon having push button 32B pushed again in the locked state, push button 32B releases the engagement of stopper 17 with cam section 15, thereby unlocking operating body 14 and being restored to the release position. This mechanism brings switch contact 16A into the first connection state from the second connection state, so that the air-conditioner, for instance, turns to the outside air introduction mode.

When switch device 30 is in the locked state and the air-conditioner stays in the inside air circulation mode, the windshield tends to invite fogginess thereon. In this case, rotary operating section 32A of input device 32 is rotated to, e.g. a predetermined position indicated by “4” that refers to a defrosting mode.

At this moment, upon being rotated to the predetermined position, rotary operating section 32A causes a side pushing section projecting outward in downward direction 102 from the lower part of operating section 32A to push working section 20A of releaser 20 projecting in rightward direction 106 from switch device 30.

Upon having working section 20A pushed, releaser 20 slides in leftward direction 105, allowing operating body 14 to be unlocked and restored to the release position. The air-conditioner thus turns to the outside air introduction mode. At this moment, input device 32 transmits a predetermined signal corresponding to the first connection state, thereby allowing the outside air to be blown from a blow-off port disposed below the windshield to remove the fogginess.

In switch device 30 in accordance with Embodiment 1, retainer spring 19 elastically contacts releasing section 20D of releaser 20 to urge releaser 20 outward. While operating body 14 is in the locked state, the pushing of working section 20A causes releaser 20 to deform retainer spring 19 elastically to remove retainer spring 19 from stopper 17. This operation releases the engagement of stopper 17 with cam section 15, and unlocks operating body 14. Since retainer spring 19 keeps the locked state and urges releaser 20 outward, it is not necessary to prepare another urging device to urge releaser 20. Switch device 30 has a small size with a small number of components with a simpler structure. This switch device 30 allows operating body 14 to be locked or unlocked without fail, and releaser 20 to perform releasing the locked state without fail.

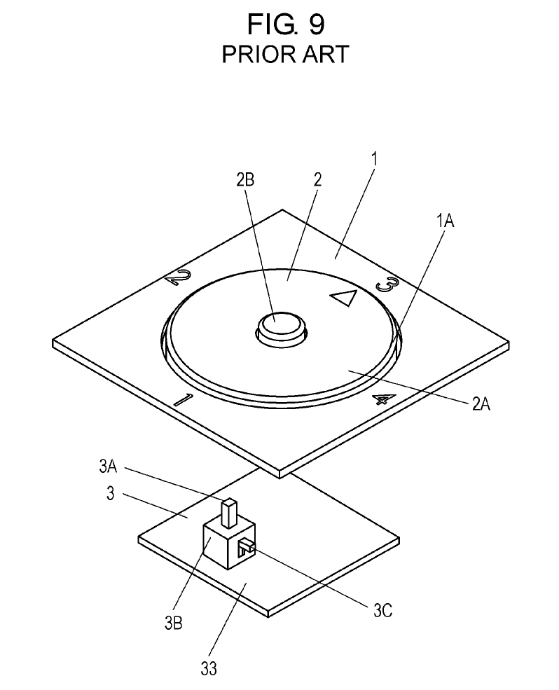

In a conventional switch device 3 shown in FIG. 9, a part of the cam section having a heart shape is formed at the end section of the releaser within the housing, and the stopper is urged by a plate spring to the cam section so that the stopper rolls on a surface of the cam section, or engages with the cam section to be retained there. The pushing of the releaser in a predetermined direction causes the part of the cam section, namely, the end section of the releaser, to push the stopper outward, thereby releasing the engagement of the stopper with the cam section. At this moment, an urging spring disposed between the releaser and an operating body urges the releaser outward. This structure involves a large number of components and invites a complicated structure, hence preventing conventional switch device 3 from having a small size.

In the conventional switch device 3, the releaser is mounted to the operating body and extends through the substantially intermediate part of the operating body, and can move in directions perpendicular to the in the upward and downward directions. The releaser moves in the upward and downward directions following the movement of the operating body in the upward and downward directions, so that an opening extending in the upward and downward directions is formed on a side surface of the housing to define a movable range of the releaser. This opening tends to allow dust to enter. In the case that switch device 3 has a dust-proof structure, a cover for shielding the opening is needed, and yet a driving body for pressing the releaser is needed, so that switch device 3 becomes bulky and complicate.

In switch device 30, releaser 20 has substantially a rectangular frame shape and is movable by sliding in leftward direction 105 and rightward direction 106, i.e. a direction substantially perpendicular to upward direction 101 and downward direction 102 along which operating body 14 moves. This arrangement allows operating body 14 to be placed inside the frame of releaser 20 such that operating body 14 is movable in the upward and downward directions, and allows releaser 20 to be strong enough as a pressing member. This structure stabilizes the operation of releaser 20, and provides switch device 30 with a small size and error-free operation.

### Exemplary Embodiment 2

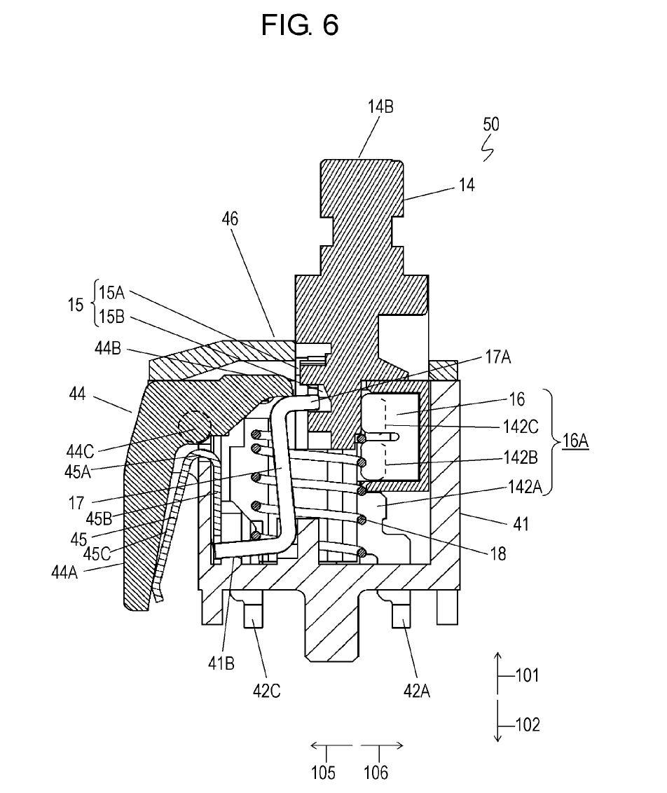

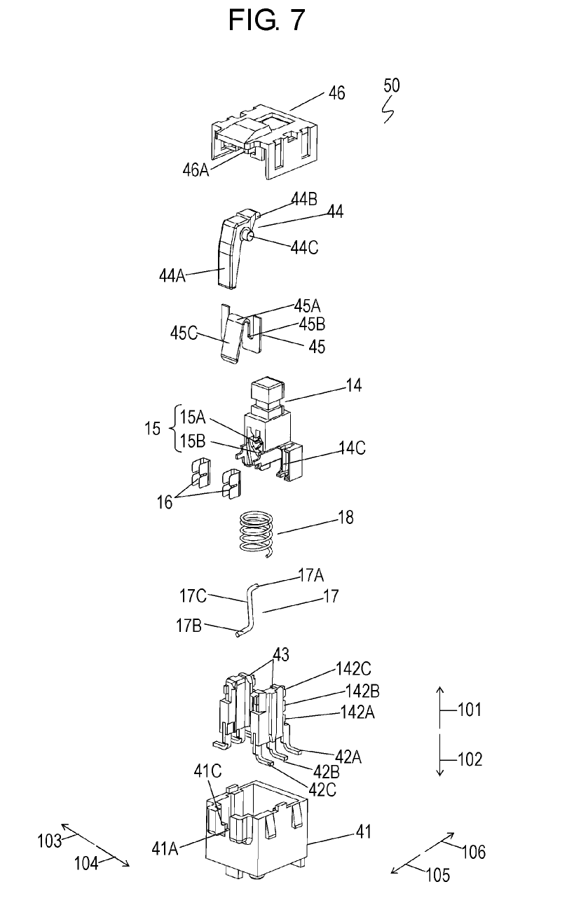

FIG. 6 and FIG. 7 are a sectional view and a perspective exploded view of switch device 50 in accordance with Exemplary Embodiment 2, respectively. In FIG. 6 and FIG. 7, components identical to those of switch device 30 shown in FIGS. 1-3 in accordance with Embodiment 1 are denoted by the same reference numerals. Housing 41 has a box shape having an opening that opens in upward direction 101, and made of insulating resin. A side surface in leftward direction 105 of housing 41 has cut-out section 41A provided therein.

Plural fixed contacts 142A, 142B, and 142C are made of conductive metal plate, such as copper alloy, and are insert-molded with insulating resin, such as PBT, thereby forming fixed contact assembly 43. Fixed contacts 142A, 142B, and 142C are arranged in this order in upward direction 101. Fixed contact assemblies 43 are fixed inside housing 11 in forward direction 103 and backward direction 104 perpendicular to upward direction 101 (downward direction 102), respectively. Fixed contacts 142A, 142B, and 142C include terminal sections 42A, 42B, and 42C at their lower sections thereof, respectively. Two fixed contact assemblies 43 face each other in forward direction 103 (backward direction 104). Terminal sections 42A, 42B, and 42C protrude from a lower surface of housing 11 in forward direction 103, and terminal sections 42A, 42B, and 42C protrude from the lower surface of housing 11 in backward direction 104. The terminal sections extend substantially in parallel with the lower surface of housing 11. Two fixed contacts 142A (two terminal sections 42A) face each other in forward direction 103 (backward direction 104). Two fixed contacts 142B (two terminal sections 42B) face each other in forward direction 103 (backward direction 104). Two fixed contacts 142C (two terminal sections 42C) face each other in forward direction 103 (backward direction 104).

FIG. 7 shows terminal sections 42A, 42B, and 42C originally extend linearly downward before the terminal sections are inserted into housing 41, and then are bent, as shown in FIG. 7.

Similarly to switch device 30 in accordance with Embodiment 1, switch device 50 in accordance with Embodiment 2 includes operating body 14 having cam section 15 provided to a side surface in leftward direction 105 of operating body 14. Operating body 14 includes compartment 14C accommodating movable contact 16 therein. Operating body 14 is urged by coil spring 18 in upward direction 101, and accommodated in housing 41 such that operating body 14 can move in upward direction 101 and downward direction 102. Upon moving in the upward and downward directions, operating body 14 establishes electrical connection and disconnection of switch contact 16A including movable contact 16 and fixed contacts 142A to 142C.

Similarly to switch device 30 in accordance with Embodiment 1, switch device 50 in accordance with Embodiment 2 includes stopper 17 that contacts small projection 41B formed on a bottom surface of housing 41, and engaging section 17A contacts groove 15B formed below cam section 15.

Releaser 44 has an inverted L-shape, and made of insulating resin, such as PBT and POM. Releaser 44 includes working section 44A protruding outside and downward from cutout section 41A of housing 41, and retaining section 44B extending inside housing 41.

Releaser 44 includes shaft 44C provided substantially at the center thereof. Shaft 44C protrudes both in forward direction 103 and backward direction 104, and is supported rotatably by recessed shaft supporter 41C formed inside housing 11 to receive shaft 44C.

The distance from shaft 44C to an end of working section 44A is longer than the distance from shaft 44C to an end of retaining section 44B.

Retainer spring 45 has an inverted V-shape that opens in downward direction 102 in a side view from forward direction 103 (backward direction 104), and is made of an elastic metal plate, such as a stainless plate or a copper alloy plate. The retainer spring 45 having the inverted V-shape has bent section 45A, side 45B extending downward from bent section 45A and disposed in rightward direction 106, and side 45C extending downward from bent section 45A and disposed in leftward direction 105. Side 45B in rightward direction 106 of retainer spring 45 is engaged with a side wall of housing 41 in leftward direction 105 and fixed there. Bent section 45A of retainer spring 45 is placed at cutout section 41A of housing 41. Side 45C of retainer spring 45 in leftward direction 105 elastically contacts inside working section 44A of releaser 44 while slightly compressing retainer spring 45, so that retainer spring 45 can urge releaser 44 clockwise viewed in backward direction 104 from releaser 44.

Cover 46 is made of insulating resin, and covers the opening in an upper surface of housing 41 and an upper surface of working section 44A of releaser 44. Cover 46 includes rotation supporting section 46A at a lower surface thereof for covering an upper section of shaft 44C. Cover 46 is mounted to housing 41, providing switch device 50.

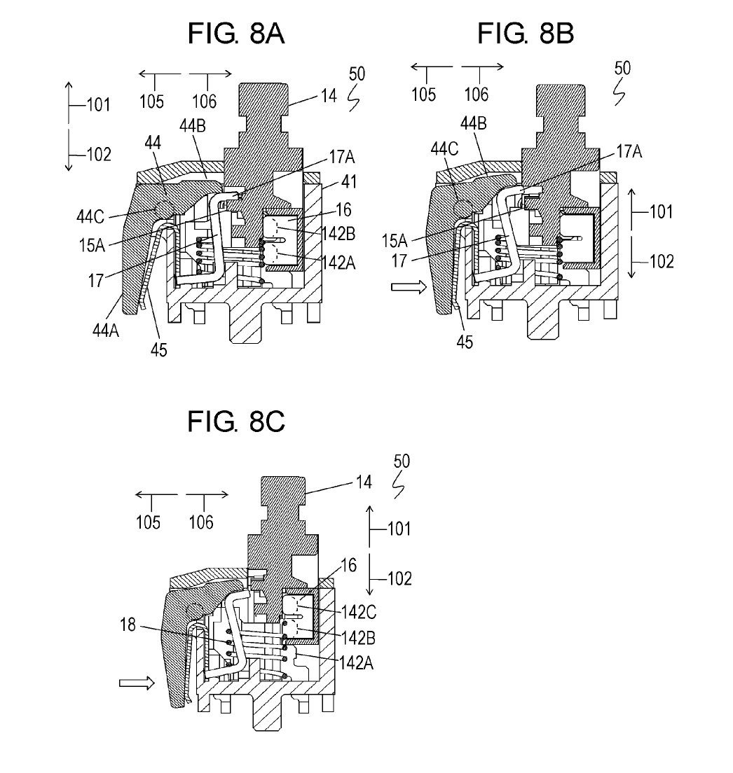

An operation of switch device 50 will be described below. FIGS. 8A to 8C are sectional views of switch device 50 for illustrating the operation of switch device 50. Similarly to switch device 30 in accordance with Embodiment 1, switch device 50 in accordance with Embodiment 2 includes operating body 14 having operating section 14B. The pressing of operating section 14B causes operating body 14 to move in the upward and downward directions, and operating body 14 is locked or unlocked by stopper 17 and cam section 15. At this moment, electric connection and disconnection is performed to switch contact 16A.

Switch device 50 is different from switch device 30 in a method of releasing the locked state by releaser 44. FIGS. 8A to 8C are sectional views of switch device 50 for illustrating the operation of switch device 50.

As shown FIG. 8A, engaging section 17A of stopper 17 is pushed by retaining section 44B of releaser 44, and allows engaging section 17A to be engaged with the upper surface of protrusion cam 15A and is retained there, thereby locking switch device 50.

In this locked state, since the distance from shaft 44C to the end of retaining section 44B is shorter than the distance from shaft 44C to the end of working section 44A, retaining section 44B pushes stopper 17 with a strong and proper force that is produced inversely proportional to the distance from shaft 44C although the urging force applied from retainer spring 45 to working section 44A is rather small.

In this locked state, working section 44A of releaser 44 is pushed toward housing 41 anticlockwise viewed from backward direction 104 of releaser 44, and then, as shown FIG. 8B, releaser 44 resists to the urging force of retainer spring 45 and rotates anticlockwise about shaft 44C viewed from backward direction 104 of releaser 44. At this moment, the rotation of releaser 44 causes retaining section 44B to rotate to remove releaser 44 from engaging section 17A of stopper 17, so that engaging section 17A leaves protrusion cam 15A, thereby unlocking switch device 50. As a result, as shown in FIG. 8C, operating body 14 is urged by coil spring 18 and restored to the release position.

An input device including switch device 50 has a structure similar to the input device according to Embodiment 1 shown in FIG. 5. However, working section 44A of releaser 44 in switch device 50 protrudes outside housing 41 in downward direction 102, so that the lateral pushing section projecting from the lower part of rotary operating section 32A is configured to press around the upper surface of wiring board 33 disposed below housing 41 of switch device 50.

In switch device 50, the distance from shaft 44C to the end of retaining section 44B is shorter than the distance from shaft 44C of releaser 44 to the end of working section 44A. This structure allows retaining section 44B to push stopper 17 with large and proper force that is produced inversely proportional to the distance from shaft 44C, although retainer spring 45 urges working section 44A with rather smaller force. As a result, load for pressing the releaser 44 can be rather smaller. This load is produced by rotating rotary operating section 32A, and is transmitted via the lateral pushing section to press the releaser 44.

As discussed above, in switch device 50 in accordance with Embodiment 2, when operating body 14 is locked, retaining section 44B of releaser 44 pushes stopper 17 with the urging force of retainer spring 45, so that stopper 17 is engaged with cam section 15 and is retained there. Then, the pushing of working section 44A of releaser 44 removes retaining section 44B from stopper 17, thereby releasing the engagement of stopper 17 with cam section 15. As a result, operating body 14 is unlocked. This mechanism allows releaser 44 that is urged by retainer spring 45 maintains the locked state, and working section 44A of releaser 44 is urged outward, so that there is no need to prepare another urging device for urging releaser 44 outward. Switch device 50 has a small size with a simple structure and a smaller number of components. Switch device 50 allows operating body 14 to lock and unlock switch device 50 without fail, or allows releaser 44 to unlock switch device 50 without fail.

Switch device 30 in accordance with Embodiment 1 includes terminal sections 12A, 12B, and 12C extending linearly from the lower surface of housing 11, and these terminal sections extend through through-holes of wiring board 33 disposed below housing 11, and the terminal sections are dip-soldered. Terminal sections 42A, 42B, and 42C of switch device 50 in accordance with Embodiment 2 are bent substantially in parallel to the lower surface of housing 41, and mounted onto land patterns formed on wiring board 33 by reflow-soldering. Switch device 30 in accordance with Embodiment 1 may include terminal sections 12A, 12B, and 12C having the same shapes as terminal sections 42A, 42B, and 42C of switch device 50 in accordance with Embodiment 2. To the contrary, terminal sections 42A, 42B, and 42C of switch device 50 in accordance with Embodiment 2 may have the same shape as terminal sections 12A, 12B, and 12C of switch device 30 in accordance with Embodiment 1. Terminal sections 12A to 12C of switch device 30 and terminal sections 42A to 42C of switch device 50 may have other shapes.

In switch devices 30 and 50 in accordance with Embodiments 1 and 2, switch contact 16A includes movable contact 16 having a clip shape and fixed contacts 112A to 112C and 142A to 142C having plate shapes. The switch contact may include fixed contacts having plate shape and a movable contact having a brush shape that faces, and elastically contacts the fixed contacts, and slides on the fixed contacts. The switch contact may include a movable contact having a dome shape and fixed contacts having plate shapes facing the movable contact having the dome shape.

In the embodiments previously discussed, terms, such as “upper surface”, “lower surface”, “upward direction”, “downward direction”, “forward direction”, “backward direction”, “rightward direction”, and “leftward direction”, indicating directions merely indicate relative directions depending on only relative positional relations of structural elements of switch devices 30 and 50, and do not indicate absolute directions, such as a vertical direction.

### INDUSTRIAL APPLICABILITY

A switch device according to the present invention includes a small number of components with a simple structure, hence having a small size. This switch device allows its operating body to lock or unlock the switch device or the releaser to unlock the switch device without fail. The switch device is useful for operating various electronic devices installed mainly in vehicles.

### REFERENCE MARKS IN THE DRAWINGS

11, 41 housing
11D engaging section
14 operating body
14B operating section
15 cam section
16A switch contact
17 stopper
17A engaging section
17B supporting section
19, 45 retainer spring
20, 44 releaser
20A, 44A working section
21, 46 cover
30, 50 switch device
32 input device

1. A switch device comprising:
a housing;
an operating body accommodated movably in the housing and including a cam section;
a stopper including an engaging section which is engaged with the cam section upon a movement of the operating body as to lock the operating body;
a switch contact performing electrical connection and disconnection in response to the movement of the operating body;
a releaser disposed in the housing and including a working section projecting outward from the housing; and
a retainer spring disposed in the housing and urging the releaser in a predetermined direction,
wherein, when the operating body is locked, one of the releaser and the retainer spring presses the stopper to engage the engaging section with the cam section and retain the engaging section at the cam section,
wherein, while the engaging section is engaged with the cam section and retained with the cam section, an operation on the working section of the releaser causes the releaser to move, and causes one of the releaser and the retainer spring to move in a direction away from the stopper as to disengage the engaging section from the cam section.

2. The switch device according to claim 1, wherein, while the operating body is locked, the retainer spring urges the releaser outward to presses the stopper, and an operation on the working section of the releaser causes the retainer spring to deform elastically and move in a direction away from the stopper.

3. The switch device according to claim 2, wherein the releaser has a frame shape, and slides in a direction substantially perpendicular to a direction of the movement of the operating body.

4. The switch device according to claim 1, wherein while the operating body is locked, the retainer spring urges the releaser in a predetermined direction, and the releaser presses the stopper, and upon an operation on the working section of the releaser, the releaser is removed from the stopper.

5. The switch device according to claim 4, wherein the releaser is supported rotatably on the housing, and the working section extends downward from the housing.
